(19) United States
(12) Patent Application Publication
(10) Pub. No.: US 2013/0041485 A1
(43) Pub. Date: Feb. 14, 2013

(54) SYSTEM AND METHOD FOR SERVICING FIELD DEVICES IN AN AUTOMATED PLANT

(71) Applicants: Michael Gunzert, Herxheim (DE); Axel Pöschmann, Basel (CH); Thomas Weinschenk, Hartheim (DE); Emilio Schiavi, Oberwil (CH); Eugenio Ferreira Da Silva Neto, Biel-Benken (CH); Michael Maneval, Schopfheim (DE)

(72) Inventors: Michael Gunzert, Herxheim (DE); Axel Pöschmann, Basel (CH); Thomas Weinschenk, Hartheim (DE); Emilio Schiavi, Oberwil (CH); Eugenio Ferreira Da Silva Neto, Biel-Benken (CH); Michael Maneval, Schopfheim (DE)

(73) Assignee: Endress + Hauser Process Solutions AG, Reinach (CH)

(21) Appl. No.: 13/568,313

(22) Filed: Aug. 7, 2012

(30) Foreign Application Priority Data
Aug. 8, 2011 (DE) 10 2011 080 569.9

(51) Int. Cl. G05B 9/02

(52) U.S. Cl. 700/79

(57) ABSTRACT

A system for servicing field devices in an automated plant with a superordinated control/service unit, wherein the superordinated control/service unit accesses the field devices via a communication network. The communication network has at the control/servicing level a first bus system with a first transmission protocol and at the field level a second bus system with a second transmission protocol. The conversion of the two transmission protocols occurs in a gateway and provided in the gateway a basic software, which, upon the occurrence of an event, scans to ascertain the field devices arranged at the field level and utilizes the ascertained information concerning the field devices, in order to download the corresponding electronic device descriptions from an application server and to provide these to the control/service unit for servicing the field devices. The application server contains server apps.

The invention relates to a system for servicing field devices in an automated plant.

In automation technology, especially in process and manufacturing automation technology, field devices are often applied, which serve for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity, respectively. Serving for influencing process variables are actuators, such as, for example, valves or pumps, via which the flow of a liquid in a pipeline section, or the fill level in a container, can be changed. Referred to as field devices are, in principle, all devices, which are applied near to the process and which deliver, or process, process relevant information. Thus, in connection with the invention, falling under field devices are also remote I/Os, radio adapters, and, generally, all devices, located at the field plane. A large number of such field devices are available from the firm, Endress+Hauser.

In modern industrial plants, communication between at least one superordinated control unit and the field devices occurs, as a rule, via a bus system, such as, for example, the Profibus® PA, Foundation Fieldbus® or HART® bus system. The bus systems can be embodied both wired as well as also wirelessly. The superordinated control unit serves for process control, process visualizing, and process monitoring as well as for start-up and servicing of the field devices and is also referred to as a configuration/management system. Programs, which run self-sufficiently on superordinated units, include, for example, servicing tools, such as the FieldCare tool of the Endress+Hauser group of firms, the Pactware tool, the AMS tool of Fisher-Rosemount or the PDM tool of Siemens. Operating, or servicing, tools, which are integrated in control system applications, include the PCS7 tool of Siemens, the Symphony tool of ABB and the Delta V tool of Emerson. Under the terminology ‘servicing field devices’ is meant especially the configuring and parametering of field devices, and, also, diagnosis for the purpose of early detecting of defects in one of the field devices or in the process.

The integration of field devices in servicing/control units occurs usually via electronic device descriptions, which enable that the servicing/control units can detect and interpret the data delivered from the field devices. As a rule, the respective device manufacturer provides device descriptions for each field device type, or for each field device type in different applications. In order that the field devices can be integrated in different fieldbus systems, different device descriptions must be created for the different fieldbus systems. Thus, there are—in order to name only some examples—HART-, Fieldbus Foundation- and Profibus-device descriptions. The number of device descriptions is very large, corresponding to the large number of different field devices, or field device types, in the different applications and bus systems. Usually, the device descriptions are stored in the respective servicing/control unit.

For the purpose of creating a unitary description language for field devices, Fieldbus Foundation (FF), HART Communication Foundation (HCF) and Profibus Nutzerorganisation (PROFIBUS User Organization, or PNO) have created a unified electronic device description language (Electronic Device Description Language EDDL). The EDDL, respectively the corresponding Electronic Device Description EDD, is defined in the standard, IEC 61804-2.

Besides the electronic device descriptions, applied in increasing measure are device type managers (DTM) or device drivers, preferably according to the FDT standard. These require, as runtime environment, a frame application. In the case of the FDT-standard, this is the FDT-frame. Device drivers are suited for comprehensive servicing of field devices.

The integration of field devices into the service/control units is done online by means of a DCS, a PLC, a notebook or other handheld tool after installation of the field device in the automated plant. Likewise known is to conduct the integration offline via a configuration/management system and then to integrate the field device into the automated plant.

Installation of the software into a service/control unit is tedious and complex, this having to do, on the one hand, with the large number of device descriptions and, on the other hand, with the dependence on the Windows technology. Added to this is the fact that the software in a typical automated plant must usually be installed in a plurality of clients.

Problematic is, furthermore, that the versions of the electronic device descriptions are always changing, i.e. a user has continuously to pay attention that the current versions of the device descriptions of the field devices installed in the plant are stored in the service/control unit. The stored device descriptions must be updated and, in given cases, newly installed. For this, the user usually has to request current device descriptions from the device manufacturer. This procedure is relatively time consuming and, moreover, also introduces the danger that wrong device descriptions get installed.

An object of the invention is to provide a system and a method for significantly simplifying installation of device descriptions in a service/control unit.

The object is achieved relative to the system by features including that a superordinated control/service unit is provided, which accesses the field devices via a communication network, wherein the communication network has at the control/servicing level a first bus system with a first transmission protocol and at the field level a second bus system with a second transmission protocol and wherein conversion between the two transmission protocols occurs in a gateway. Further provided in the gateway is a basic software, which, upon the occurrence of an event, scans to ascertain the field devices arranged at the field level and utilizes the information ascertained concerning the field devices, in order to download the corresponding electronic device descriptions from an application server and to provide these to the control/service unit for servicing the field devices, wherein the application server (6) contains server apps. The application server is provided, for example, by a device manufacturer and/or device suppliers.

An alternative embodiment provides that, not the gateway 2, but, instead, a client connectable with the communication network 3 fulfills the above described functions. The advantage of the computer solution compared with the gateway solution is that significantly greater computing power is available in the computer. The disadvantage of this alternative is that the additional IT infrastructure must, in given cases, be updated and cared for.

Preferably, the first transmission protocol is an Ethernet-protocol, while the second transmission protocol at the field level is a fieldbus protocol conventional in automation technology. Examples of such fieldbus protocols were already named above.

The event can be, especially, the start-up of the automated plant, the start-up of a field device or the issuing of a command for starting the scanning. Of course, these examples do not represent an exclusive listing.

An advantageous embodiment of the system of the invention provides in the application server a database, which contains information for identification of the field devices as well as the corresponding device descriptions.

Preferably, the basic software associated with the gateway includes at least one server app. In this connection, it is, moreover, provided that the server app is an interpreter app, which interprets and/or executes, at run time, electronic device descriptions down loaded from the server, wherein the electronic device descriptions are used for comprehensive servicing of the field devices.

Furthermore, at least one client app is provided in the control/service unit. With the client app, likewise, required apps can be downloaded from the application server into the control/service unit.

Preferably, the control/service unit is a stationary servicing tool, such as a PC, or a mobile servicing tool, such as a laptop, a Smart phone, e.g. an iPhone, an iPad, etc.

An advantageous further development of the system of the invention provides that the client app, or client apps, run in the Internet, wherein access to the client app, or client apps, occurs via a browser.

Thus, an alternative embodiment of the system of the invention provides, instead of the server apps in the gateway, a server app in a computing unit connected, or connectable, with the bus system. In such case, the server app is so embodied that by means of scanning, the field devices arranged at the field level are ascertained, and the ascertained information concerning the field devices is utilized, in order to download the corresponding electronic device descriptions from a server into the connected computing unit and to provide such to the control/service unit for servicing the field devices.

The object is achieved as regards method for servicing field devices in an automated plant by means of a superordinated control/service unit by features including that the superordinated control/service unit accesses the field devices via a communication network, wherein the communication network has at the control/servicing level a first bus system with a first transmission protocol and at the field level a second bus system with a second transmission protocol, and wherein conversion between the two transmission protocols occurs in a gateway. Upon the occurrence of an event, the gateway ascertains, by means of scanning, the field devices arranged at the field level and uses the ascertained information concerning the field devices to download from an application server electronic device descriptions corresponding to the ascertained field devices and to provide such to the control/service unit for servicing the field devices. The term “provide” includes here, especially, that the electronic device descriptions are loaded into the gateway and interpreted, or executed, there. In this way, a client has the opportunity to access the gateway and to utilize, via the gateway, functions, which are stored in the one or more electronic device descriptions.

The invention will now be explained in greater detail based on the drawing, the sole figure of which shows as follows:

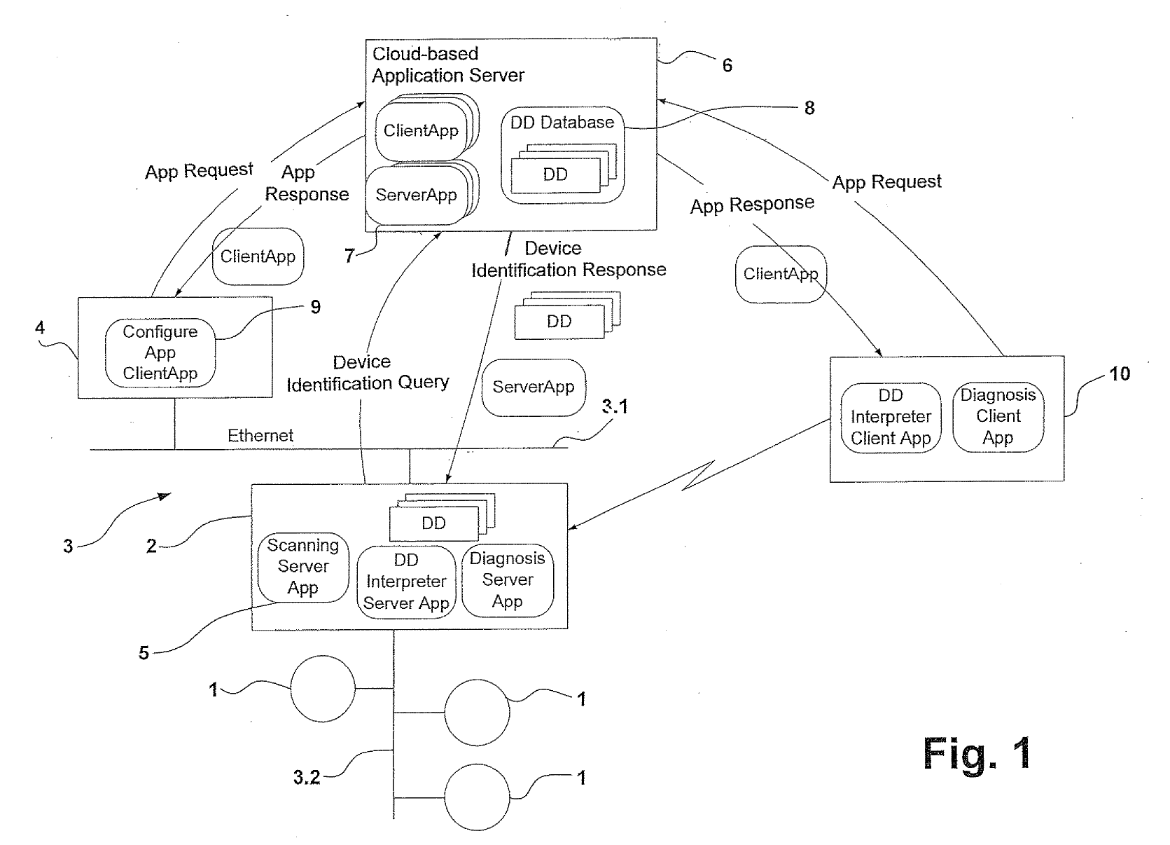

FIG. 1 schematic representation of a preferred embodiment of the system of the invention for servicing field devices 1 in an automated plant, demonstrating, simultaneously, method steps of the method of the invention.

With reference to FIG. 1, the superordinated control/service unit 4—or, generally stated, client 4—communicates via the communication network 3 with the field devices 1. The communication network 3 is composed, in the illustrated variant, of two bus systems 3.1, 3.2: Communication occurring on the bus system 3.1, which is arranged at the control/servicing level, is via an Ethernet protocol, while on the bus system 3.2, which enables communication at the field level, communication is via one of the fieldbus protocols customary in automation technology. Examples of fieldbus protocols are named above. Conversion between the two protocols occurs in the gateway 2. If communication at the control/servicing level and the field level occurs, instead, via the same protocol, then the need for the conversion is absent and the functionality of the gateway is that of a field access unit PAP (Plant Access Point).

The device manufacturer or the device supplier provides an application server 6 for customers. Available in the application server 6 are different apps 7; in the illustrated case, the apps are subdivided into client apps and server apps. Furthermore, there is provided in the application server 6 a database 8, which makes available electronic device descriptions DD corresponding to the field devices 1. If the identification data for the field devices 1 are delivered to the application server 6, then, based on the database 8, the device descriptions DD corresponding to the field devices 1 can be ascertained and provided.

Let us consider the case of the first start-up of an automated plant with a large number of field devices 1. In the gateway 2, or the field access unit, at the beginning. only basic software 5 is implemented. Via the basic software, the gateway 2 is able to contact the application server 6 and to download required server apps 7. These server apps 7 include at least one scanning server app and, in given cases, an interpreter server app.

As soon as at least the scanning server app has been downloaded into the gateway 2, the scanning server app initiates a scan; a so-called fieldbus scan is performed, via which the field devices arranged at the field level 1 are identified. Then, a query with the identification data of the identified field devices 1 is sent to the application server 6, and the required device descriptions DD are pulled out and downloaded into the gateway 2.

There, they are interpreted and/or executed in the interpreter server app. Via the device driver DTM, a comprehensive servicing of the field devices 1 is possible. The meaning of the term “servicing” has been explained above. Since now the automated plant has available, at any time, the current device driver DTM, the occurrence of errors in the servicing of the field devices 1 can almost completely be excluded.

The servicing of the field devices 1 occurs either via the mobile servicing device 10 or the service/control unit 4. For this, there have been downloaded into the mobile servicing device 10 two client apps: A DD interpreter client app and a diagnosis client app. The considerable advantage of this solution is that the computing power present in usual PCs, laptops, etc. can be fully utilized for servicing in the field. In the illustrated case, the mobile servicing device and the gateway 2 communicate, moreover, wirelessly via radio. This naturally does not represent a limitation.

If the event is the integration of a new field device 1 into the automated plant or a corresponding command for starting the scanning (a manual or an automatically triggered scan), then so far unknown field devices 1 are identified and the corresponding device descriptions DD downloaded in the gateway 2.

Further provided in the gateway 2 in the illustrated case is a diagnosis server app. Via the diagnosis server app, a diagnosis of the field devices 1 connected to the communication network 3 can be performed, for example, via the mobile servicing device 10, without it being necessary that other software components first be installed in the mobile servicing tool 10. The mobile servicing device 10 has downloaded the required client app of the application server 6 via the Internet. Likewise, the service/control unit 4 can obtain required apps 7 from the application server 6 via corresponding queries.

The solution of the invention offers the following advantages:
The customer needs no longer to concern itself with finding the correct device driver, followed by downloading, installing and updating. The responsibility for this is now assumed by the device manufacturer, or the device suppliers.
The gateway is preferably automatically configured and detects automatically the field devices 1 connected to the communication network 3. The correct device descriptions are automatically identified and downloaded in the gateway 2.
Newly installed field devices 1 are always automatically identified, and the required device descriptions DD are automatically downloaded from the application server 6.
The user does not have to install complex applications on its desktop computer or on its mobile servicing device.
Device driver DTMs do not have to be time consumingly installed in the service/control unit 4.
The client apps significantly simplify device integration and device configuration (plug & play).

### LIST OF REFERENCE CHARACTERS

1 field device
2 gateway
3 communication network
3.1 first bus system
3.2 second bus system
4 service/control unit
5 basic software
6 application server
7 server app
8 database
9 client app
10 mobile servicing device

1-13. (canceled)

14. A system for servicing field devices in an automated plant, comprising:
a communication network;
a gateway;
an application server; and
a superordinated control/service unit, which accesses the field devices via said communication network, wherein:
said communication network has at a control/servicing level a first bus system with a first transmission protocol and at a field level a second bus system with a second transmission protocol;
conversion between the two transmission protocols occurs in said gateway;
there is provided in said gateway a basic software, which, upon occurrence of an event, scans to ascertain the field devices arranged at the field level and utilizes the ascertained information concerning the field devices, in order to download corresponding electronic device descriptions from said application server and to provide these to said control/service unit for servicing the field devices; and
said application server contains server apps.

15. The system as claimed in claim 14, wherein:
said first transmission protocol is an Ethernet protocol.

16. The system as claimed in claim 14, wherein:
said second transmission protocol at the field level is a fieldbus protocol conventional in automation technology.

17. The system as claimed in claim 14, wherein:
the event is one of:
especially, start-up of the automated plant, start-up of a field device, or issuing of a command for starting the scanning.

18. The system as claimed in claim 14, wherein:
there is provided in said application server a database, which contains information for identification of the field devices as well as the corresponding device descriptions.

19. The system as claimed in claim 14, wherein:
said basic software associated with said gateway includes at least one server app.

20. The system as claimed in claim 14, wherein:
the server app is an interpreter app, which at runtime converts the electronic device descriptions downloaded from said application server into device drivers for servicing of the field devices.

21. The system as claimed in claim 20, wherein:
at least one client app is provided in said control/service unit.

22. The system as claimed in claim 14, wherein:
said control/service unit is one of:
a stationary servicing tool and a mobile servicing tool.

23. The system as claimed in claim 21, wherein:
the client app, or the client apps, run in the Internet; and
access to the client app, or client apps, occurs via a browser.

24. The system as claimed in claim 14, wherein:
instead of the server apps in said gateway, a server app is provided in a computing unit connected, or connectable, with said bus system;
said server app is so embodied that by means of scanning the field devices arranged at the field level are ascertained, and the ascertained information concerning the field devices is utilized, in order to download the corresponding electronic device descriptions from a server into the connected computing unit and to provide such to said control/service unit for servicing the field devices.

25. A method for servicing field devices in an automated plant with a superordinated control/service unit, comprising the steps of:
accessing the field devices by the superordinated control/service unit accesses via a communication network;
providing the communication network at a control/servicing level a first bus system with a first transmission protocol and at a field level a second bus system with a second transmission protocol;
converting between the two transmission protocols in a gateway;
upon the occurrence of an event, the gateway establishes a connection to an application server, downloads a scanning server app, ascertains by means of scanning, the field devices arranged at the field level and utilizes the ascertained information concerning the field devices to download from an application server electronic device descriptions or device driver corresponding to the ascertained field devices; and
provides, on the occurrence of said event, such to the control/service unit for servicing the field devices.

26. The method as claimed in claim 25, wherein:
the electronic device descriptions are loaded into the gateway and interpreted, or executed, there; and
a client can access the gateway and utilize via the gateway functions, which are stored in one or more electronic device descriptions.
